(19) United States
(12) Patent Application Publication
(10) Pub. No.: US 2002/0172522 A1
(43) Pub. Date: Nov. 21, 2002

(54) Image forming apparatus capable of correcting control coefficient used to determine electrification bias

(75) Inventor: Nobuhiro Hayashi, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 10/144,130

(22) Filed: May 14, 2002

(30) Foreign Application Priority Data
May 16, 2001 (JP) 2001-146974

(51) Int. Cl. G03G 15/02

(52) U.S. Cl. 399/48; 399/50

(57) ABSTRACT

In an image forming apparatus, an image bearing member bears an electrostatic image. An electrification device electrifies the image bearing member to a predetermined potential. An exposure device exposes the image bearing member electrified by the electrification device to an image. A potential detection device detects the potential of the image bearing member. A determination device performs calculation using a control coefficient for the potential detected by the potential detection device, and determines an electrification bias value. The determination device corrects the control coefficient to determine an electrification bias when the detected potential upon electrification at the electrification bias obtained by calculation falls outside a predetermined range.

### BACKGROUND OF THE INVENTION

1. Field of the Invention

The present invention relates to an electrophotographic image forming apparatus such as a copying machine or printer.

2. Related Background Art

Conventional image forming apparatuses include an electrophotographic copying machine, laser beam printer, and laser facsimile apparatus.

In the electrophotographic image forming apparatus, the electrification and exposure characteristics of the photosensitive drum vary depending on environmental conditions or changes over time. The image quality must be adjusted by properly adjusting the electrification potential (dark portion potential) by the electrification means and the exposure potential (light portion potential) by the exposure means in activation of the apparatus or before image formation.

Japanese Patent Application Laid-Open No. 50-81662 discloses a simple control method using linear approximation. In the first control executed in activation or prior to image formation after a long idle time, the electrification means is driven by two current values I₁ and I₂ to measure electrification potentials V_{D1} and V_{D2} of the photosensitive drum at the respective current values. A control coefficient (slope of a straight line I-V) is obtained from these values, and a current value I₃ which provides a target potential is calculated based on the control coefficient. In the second control executed prior to image formation after a short idle time, a current value I₄ which provides a target potential is easily calculated using the current value I₃ and control coefficient obtained in advance.

This control method must perform two or more control operations in the first control even if the electrification and exposure characteristics of the photosensitive drum do not vary. The loss of time undesirably delays the first printing time.

The control method assumes that the current value and electrification potential are linear, and that the characteristics of the photosensitive drum vary linearly.

However, the electrification characteristic (exposure characteristic) does not always linearly vary depending on changes of the photosensitive drum over time or environmental changes. In this case, the validity of the default current values I₁, and I₂ is low, and an error becomes large between a potential calculated by linear approximation and an actual target potential. Especially in the second control using the previously calculated control coefficient, the reliability of the control coefficient is low. The number of control operations increases, and the convergence precision may decrease.

### SUMMARY OF THE INVENTION

It is an object of the present invention to provide an image forming apparatus capable of decreasing the number of electrification potential control operations.

It is another object of the present invention to provide an image forming apparatus capable of obtaining a high-reliability control coefficient.

It is still another object of the present invention to provide an image forming apparatus comprising:

an image bearing member which bears an electrostatic image;

electrification means for electrifying the image bearing member to a predetermined potential;

exposure means for exposing the image bearing member electrified by the electrification means to an image;

potential detection means for detecting a potential of the image bearing member; and

determination means for performing calculation using a control coefficient for the potential detected by the potential detection means, and determining an electrification bias value,

wherein the determination means corrects the control coefficient to determine an electrification bias when the detected potential upon electrification at the electrification bias obtained by calculation falls outside a predetermined range.

The above and other objects, features, and advantages of the present invention will be apparent from the following detailed description of the preferred embodiments in conjunction with the accompanying drawings.

### BRIEF DESCRIPTION OF THE DRAWINGS

FIG. 1 is a schematic view showing the arrangement of an image forming apparatus according to an embodiment of the present invention;

FIG. 2 is timing charts showing an example of electrification potential control operation in the image forming apparatus of FIG. 1;

FIG. 3 is a graph showing the relationship between a driving current supplied to an electrification device and the electrification potential of a photosensitive drum;

FIG. 4 is timing charts showing an example of exposure potential control operation in the image forming apparatus of FIG. 1; and

FIG. 5 is a graph showing the relationship between a driving voltage applied to an illumination lamp and the exposure potential of the photosensitive drum.

### DETAILED DESCRIPTION OF THE PREFERRED EMBODIMENTS

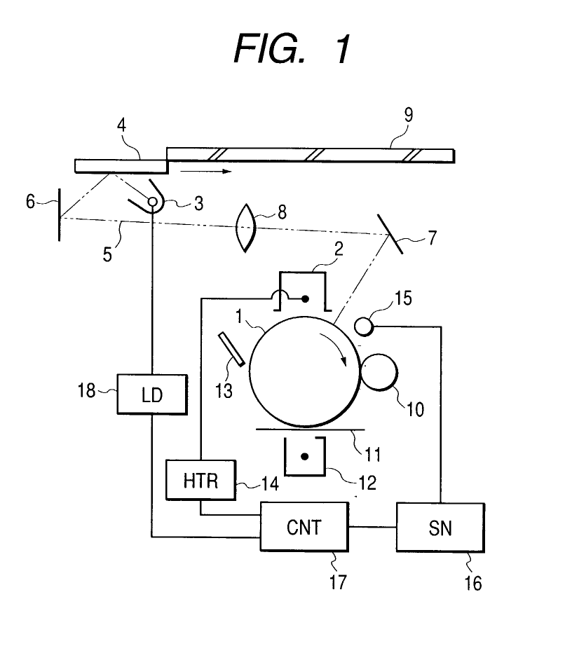

FIG. 1 is a schematic view showing the arrangement of an image forming apparatus according to an embodiment of the present invention.

As shown in FIG. 1, in the image forming apparatus of the embodiment, an electrification device 2, developing device 10, transfer electrification device 12, and cleaning blade 13 are arranged around a photosensitive drum 1 serving as an image bearing member which bears an electrostatic latent image. An illumination lamp 3, and an optical system (mirror 6, lens 8, and mirror 7) for guiding, as exposure light, reflected light of light emitted by the illumination lamp 3 are arranged above the photosensitive drum 1.

The electrification device 2 is an electrification means for receiving a driving current from a high-voltage transformer (HTR) 14 and uniformly electrifying the photosensitive drum 1. This embodiment adopts a corona electrification device for electrifying the photosensitive drum 1 by corona discharge in a noncontact manner.

The illumination lamp 3 receives a driving voltage from a lighting circuit (LD) 18 to irradiate an original set on an original glass 9. Light reflected by the original surface is guided as exposure light onto the photosensitive drum 1 via the optical system made up of the mirrors 6 and 7 and the lens 8, and forms an electrostatic latent image. In this embodiment, the illumination lamp 3 and optical system constitute an exposure means.

The developing device 10 is a developing means for attracting a developer (toner) to the electrostatic latent image formed on the photosensitive drum 1 and visualizing the image. The transfer electrification device 12 is a transfer means for transferring the toner image on the photosensitive drum 1 to a transferring sheet 11.

Image forming operation in the image forming apparatus having the above arrangement will be explained.

When a controller (not shown) generates a copy start signal, the photosensitive drum 1 rotates in a direction indicated by an arrow in FIG. 1. The electrification device 2 uniformly electrifies the surface of the photosensitive drum 1 to a target potential.

While irradiating an original set on the original glass 9, the illumination lamp 3 moves in a direction indicated by an arrow in FIG. 1 together with the mirror 6 to scan the original surface. The light reflected by the original surface is deflected by the mirror 6, converged by the lens 8, and guided as exposure light onto the photosensitive drum 1 by the mirror 7. As a result, the original image is formed on the photosensitive drum 1 to form an electrostatic latent image.

The electrostatic latent image is visualized into a toner image by the developing device 10. The toner image is transferred by the transfer electrification device 12 onto the transferring sheet 11 conveyed in synchronism with the rotation of the photosensitive drum 1. After the cleaning blade 13 removes a residual toner from the photosensitive drum 1, the photosensitive drum 1 is electrified again and continuously repeats the same operation.

The toner image is fixed by a fixing means (not shown), and the transferring sheet 11 bearing the original image (toner image) is discharged outside the apparatus, completing image forming operation.

An arrangement and control operation concerning potential control in the image forming apparatus of the embodiment will be described.

As shown in FIG. 1, a potential sensor 15 serving as a potential detection means for detecting the surface potential of the photosensitive drum 1 is arranged near the photosensitive drum 1. The output of the potential sensor 15 is connected to a control circuit (CNT) 17 via a detection circuit (SN) 16.

The control circuit 17 is mainly comprised of a CPU serving as an arithmetic means for performing potential control calculation, a flash memory serving as a storage means which is used as an arithmetic work area or stores a control coefficient and other data, and a ROM which stores a potential control program. The control circuit 17 is connected to the high-voltage transformer 14 of the electrification device 2 and the lighting circuit 18 of the illumination lamp 3. The control circuit 17 is a control means for controlling a driving current output from the high-voltage transformer 14 and a driving voltage applied by the lighting circuit 18, and properly adjusting the electrification potential (dark portion potential) and exposure potential (light portion potential).

Potential control by the control circuit 17 is executed prior to the above-described image forming operation. The control circuit 17 controls the electrification potential (dark portion potential) of the electrification device 2, and after it stabilizes, controls the exposure potential (light portion potential) of the illumination lamp 3.

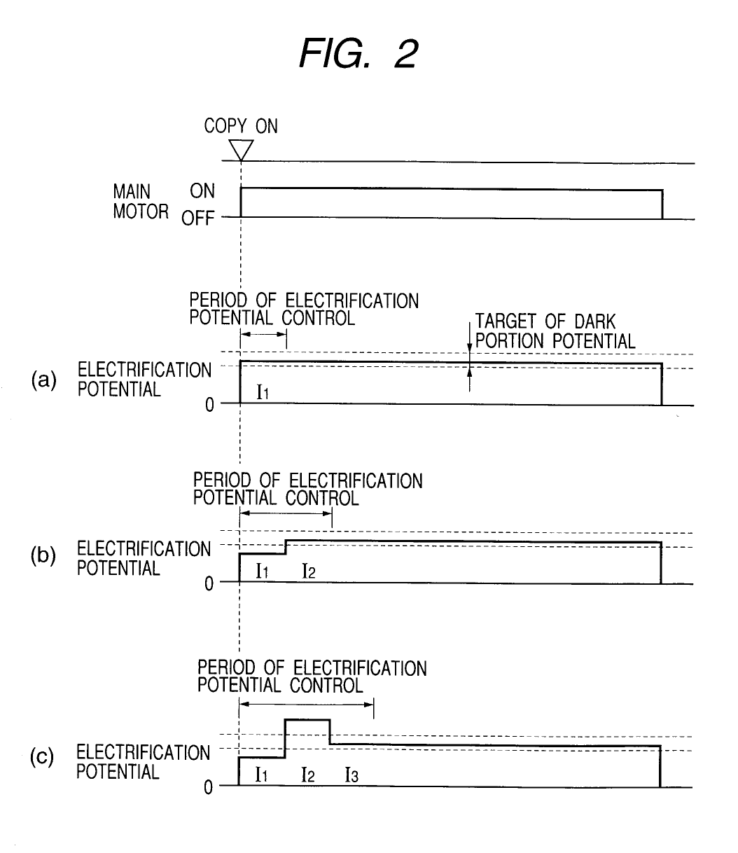

As shown in FIG. 2, the control circuit 17 turns on the high-voltage transformer 14 simultaneously when a main motor (not shown) for rotating and driving the photosensitive drum 1 and the like is activated. At this time, the control, circuit 17 causes the high-voltage transformer 14 to output a current value I₁, [μA] which has been stored in the flash memory in advance in order to measure the dark portion potential of the photosensitive drum 1 (first control). The photosensitive drum 1 is electrified by the electrification device 2. An electrification potential V_{D1} at this time is detected by the potential sensor 15 and input to the control circuit 17 via the detection circuit 16.

If the detected electrification potential V_{D1} falls within a target V_{DT} of the dark portion potential ±10 [V], as shown in a timing diagram (a) of FIG. 2, the control circuit 17 ends the control, and shifts to exposure potential control. If the electrification potential V_{D1} cannot fall within the target range in the first control, the control circuit 17 executes the second control.

In the second control, the control circuit 17 calculates a new current value I₂ by equation (1) using the electrification potential V_{D1} detected in the first control, and the current value I₁, and control coefficient α₁ which are stored in the flash memory. The control circuit 17 causes the high-voltage transformer 14 to output the current value I₂. Then, the photosensitive drum 1 is electrified by the electrification device 2. An electrification potential V_{D2} at this time is detected by the potential sensor 15 and input to the control circuit 17 via the detection circuit 16.

I₂=I₁−α₁×(V_{D1}−V_{D2}) (1)

If the detected electrification potential V_{D2} falls within the target V_{DT} of the dark portion potential ±10 [V], as shown in a timing diagram (b) of FIG. 2, the current value I₂ is stored instead of the current value I₁ stored in the flash memory. The control circuit 17 ends the control, and shifts to exposure potential control. If the electrification potential V_{D2} cannot fall within the target range in the second control, the control circuit 17 executes the third control.

In the third control, the control circuit 17 calculates a new control coefficient α₂ by equation (2) using the current value I₁ supplied in the first control, the corresponding electrification potential V_{D1}, the current value I₂ supplied in the second control, and the corresponding electrification potential V_{D2}.

α₂=(I₂−I₁)/(V_{D2}−V_{D1}) (2)

The control circuit 17 calculates a new current value I₃ by equation (3) using the new control coefficient α₂, the current value I₂ in the second control, and the electrification potential V_{D2}. The control circuit 17 causes the high-voltage transformer 14 to output the current value I₃ (a timing diagram (c) of FIG. 2). The photosensitive drum 1 is electrified by the electrification device 2. An electrification potential V_{D3} at this time is detected by the potential sensor 15 and input to the control circuit 17 via the detection circuit 16.

I₃=I₂−α₂×(V_{D2}−V_{DT}) (3)

After the detected electrification potential V_{D3} is confirmed to fall within the target V_{DT} of the dark portion potential ±10 [V], the current value I₃ supplied in the third control and the newly calculated control coefficient α₂ are stored in place of the current value I₁ and control coefficient α₁ stored in the flash memory. After that, the control circuit 17 ends the control.

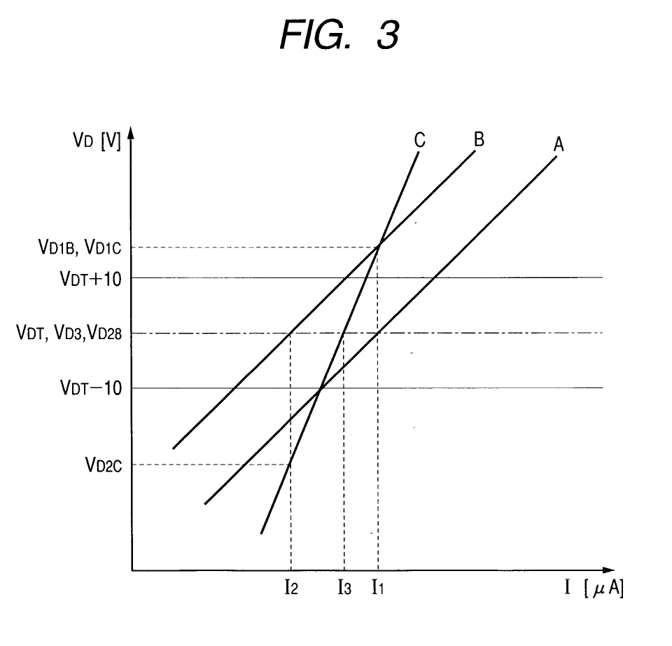

The significance of the first to third control operations and the respective equations will be additionally explained with reference to the graph of FIG. 3. FIG. 3 is a graph showing the relationship between a driving current supplied to the electrification device and the electrification potential of the photosensitive drum.

Letting I₁ be the current value first stored in the flash memory and α₁ be control coefficient, the current value I₁ is output in the first control to measure the electrification potential V_{D1} of the photosensitive drum. At this time, if the current-potential characteristic does not change from that of the previous control (straight line A is kept unchanged), V_{D1}≅V_{DT} holds, and the control ends.

If the electrification characteristic of the photosensitive member shifts almost parallel, like a straight line B, an electrification potential V_{D1B} upon electrification at the current value I₁ deviates from the range of V_{DT}±10 [V]. To prevent this, the current value I₂ calculated by equation (1) is output in the second control to measure an electrification potential V_{D2B} of the photosensitive drum. Since the straight line B has almost the same slope as that of the straight line A, V_{D2B}≅V_{DT} holds. The current value stored in the memory is updated to I₂, and the control ends. In the next potential control, the current value I₂ is supplied in the first control, and the electrification potential reaches the target potential by one control at high possibility. Note that the control coefficient α₁ corresponds to the slope of the straight lines A and B.

The electrification characteristic of the photosensitive member may change its slope, like a straight line C. In this case, the electrification potential is difficult with a large error to converge to the target potential even by using the control coefficient α₁. In this case, an electrification potential V_{D1C} upon outputting the current value I₁ deviates from the range of V_{DT}±10 [V], as shown in FIG. 3. An electrification potential V_{D2C} upon outputting the current value I₂ calculated by equation (1) in the second control also deviates from the range of V_{DT}±10 [V].

In this case, the third control is executed. First, a new control coefficient α₂ is calculated by equation (2). Then, a new current value I₃ is calculated using the control coefficient α₂, and the electrification potential V_{D3} of the photosensitive drum upon outputting the current value I₃ is measured. Since the control coefficient α₂ corresponds to the slope of the straight line C, V_{D3}≅V_{DT} holds. The calculated control coefficient α₂ and current value I₃ are stored in the flash memory instead of the control coefficient α₁ and current value I₁, and the control ends.

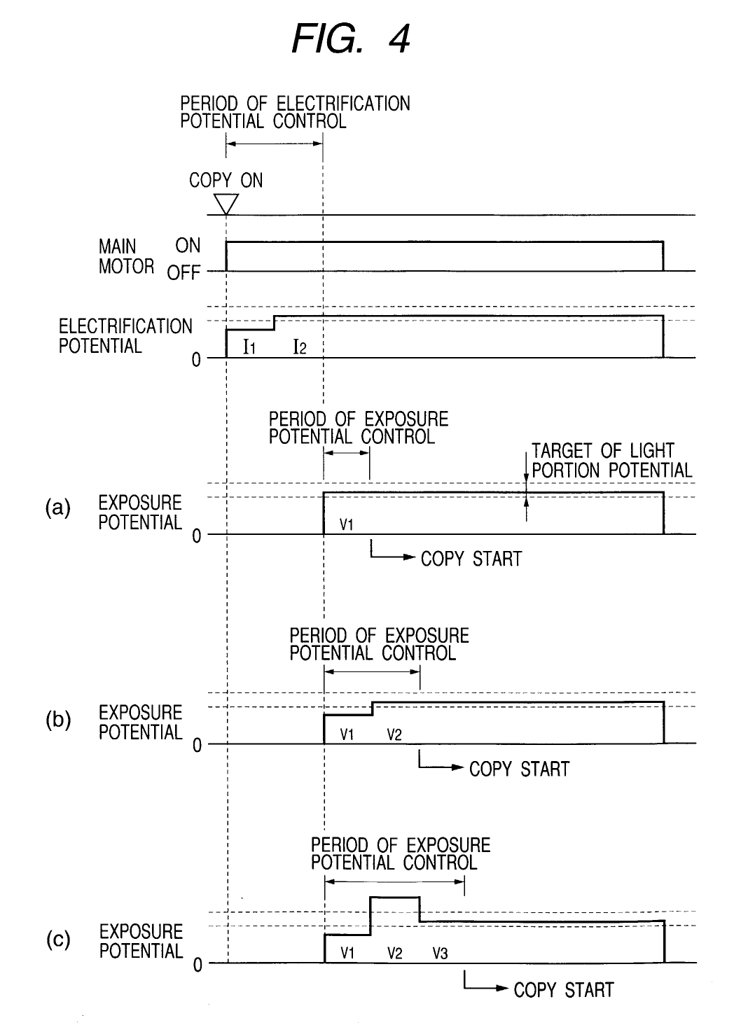

After control of the electrification potential (dark portion potential) ends, control of the exposure potential (light portion potential) starts. FIG. 4 is timing charts showing an example of potential control operation of the exposure potential.

After the photosensitive drum 1 is electrified to the electrification potential V_{DT} by the current value I₂ determined by the above-mentioned electrification potential control, the control circuit 17 turns on the lighting circuit 18. The control circuit 17 turns on the illumination lamp 3 at an ON voltage v₁ [V] stored in advance in the internal memory (storage means) of the lighting circuit 18. Illumination light from the illumination lamp 3 is reflected by a standard white plate 4 attached aside the original glass 9. The reflected light is incident as exposure light on the photosensitive drum 1 via the optical system. The surface potential of the photosensitive drum 1 after exposure is detected by the potential sensor 15, and input to the control circuit 17 via the detection circuit 16.

If the detected exposure potential V_{L1} falls within a target V_{LT} of the light portion potential ±10 [V], as shown in a timing diagram (a) of FIG. 4, the control circuit 17 ends the potential control on the stage of the first control, and starts copying (image forming operation).

If the exposure potential V_{L1} does not fall within the target V_{LT} of the light portion potential ±10 [V], the second and third exposure potential control operations are executed, similar to electrification potential control. Equations used in exposure potential control are as follows:

v₂=v₁+β₁×(V_{L1}−V_{LT}) (4)

β₂=(v₂−v₁)/(V_{L2}−V_{L1}) (5)

v₃=v₂+β₂×(V_{L2}−V_{LT}) (6)

Equations (4) to (6) concerning exposure potential control correspond to equations (1) to (3) concerning electrification potential control. Exposure potential control is different from electrification potential control in that the lamp ON voltage v and control coefficient β replace the current value I and control coefficient α.

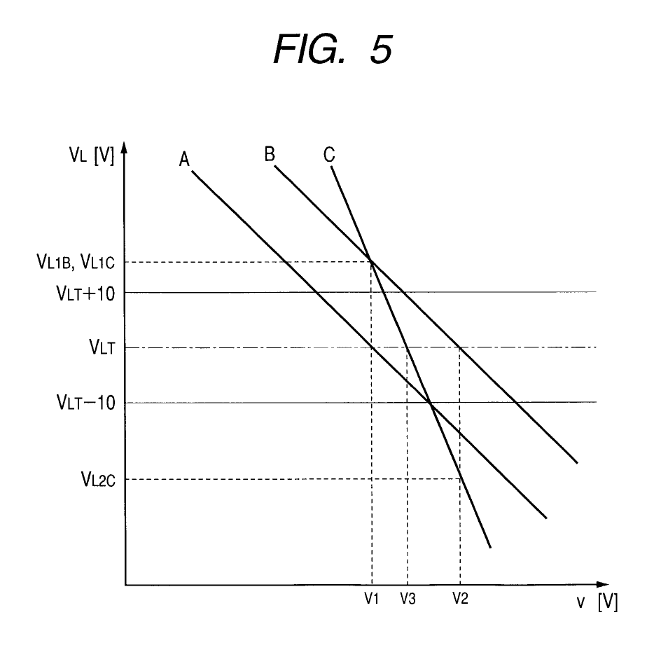

Also in control of the exposure potential (light portion potential), the first control is performed using the ON voltage v₁ stored in the memory, as shown in the graph of FIG. 5. If the target of the light portion potential cannot be attained (straight line B or C is kept unchanged), the second control of calculating a new ON voltage v₂ on the basis of equation (4) and performing exposure is executed. If the target of the light portion potential cannot be obtained even by the second control (straight line C is kept unchanged), a new control coefficient β₂ is calculated by equation (5), and an ON voltage v₃ is calculated by equation (6) using the control coefficient β₂ (third control)

If the exposure potential reaches the target of the light portion potential, an ON voltage and control coefficient at this time are stored in the memory, similar to electrification potential control. The ON voltage v and control coefficient β are stored in the internal memory of the lighting circuit 18 in this embodiment, but may be stored in the flash memory of the control circuit 17.

As has been described above, according to the embodiment, control operation is performed using the current value I₁, and voltage value v₁ stored in the memory in the first control. Control is completed by one operation when the electrification and exposure characteristics of the photosensitive drum 1 hardly vary. Image forming operation can start as fast as possible.

If the characteristics greatly vary and the potential does not converge to a target potential by one control, the second control is executed using the control coefficients α₁ and β₁ stored in the memory. For linear variations in the characteristics of the photosensitive drum 1, the target potential can be obtained by the second control. An obtained current value and voltage value are stored in the memory, which enables exploiting them in the first control in the next potential control. The potential can reach the target potential by one control at high possibility.

If the potential does not converge to the target potential even by the second control, a new control coefficient is calculated from the first and second measurement values to perform the third control, and the new control coefficient is stored in the memory. The control coefficient can be corrected to converge the potential to the target potential with high precision even upon nonlinear variations in the characteristics of the photosensitive drum 1 owing to changes of the photosensitive drum 1 over time or changes in the installation location (environment) of the apparatus main body.

In this way, the number of control operations is adaptively changed in accordance with changes in the characteristics of the photosensitive drum 1. Control results are fed back to update the control coefficient, current value, and voltage value stored in the memory at any time. High-reliability latent image potential control can be quickly achieved under any conditions, and a short first printing time and high image quality can be realized.

The above embodiment employs a corona electrification device as an electrification means, and an illumination lamp as an exposure means. The present invention is not limited to this arrangement, and can provide the same effects as those described above even with another arrangement using another means such as a roller electrification device as an electrification means and a laser exposure device as an exposure means (when image exposure is done using a laser, dark and light portion potentials are opposite from those in the embodiment).

The above embodiment adopts a sequence of controlling the potential every copying. For a stable-potential system, the potential need not be controlled every time. The standby time in control is desirably minimized by selecting the control timing in accordance with the arrangement or operation of each apparatus, such as every predetermined time, every predetermined number of copies, every predetermined idle time, or every main switch ON operation.

In the above embodiment, the driving current is adjusted in controlling the electrification potential, and the driving voltage is controlled in controlling the exposure potential. The current and voltage are not limited to them. A driving voltage applied to the electrification means may be controlled, or a driving current supplied to the exposure means may be adjusted. Also in this case, the same control as that in the embodiment can be achieved.

The embodiments of the present invention have been described above. The present invention is not limited to these embodiments, and can be variously modified within the spirit and scope of the present invention.

What is claimed is:

1. An image forming apparatus comprising:
an image bearing member which bears an electrostatic image;
electrification means for electrifying said image bearing member to a predetermined potential;
exposure means for exposing said image bearing member electrified by said electrification means to an image;
potential detection means for detecting a potential of said image bearing member; and
determination means for performing calculation using a control coefficient for the potential detected by said potential detection means, and determining an electrification bias value,
wherein said determination means corrects the control coefficient to determine an electrification bias when the detected potential upon electrification at the electrification bias obtained by calculation falls outside a predetermined range.

2. An apparatus according to claim 1, wherein said apparatus further comprises storage means for storing the control coefficient, and said storage means stores a newest control coefficient.

3. An image forming apparatus comprising:
a photosensitive member;
electrification means for electrifying said photosensitive member;
exposure means for exposing said photosensitive member electrified by said electrification means to an image;
potential detection means for detecting a potential of said photosensitive member; and
determination means for performing calculation using a control coefficient for the potential detected by said potential detection means, and determining a driving value of said exposure means,
wherein said determination means corrects the control coefficient to determine a driving value when the detected potential upon image exposure at the driving value obtained by calculation falls outside a predetermined range.

4. An apparatus according to claim 3, wherein said apparatus further comprises storage means for storing the control coefficient, and said storage means stores a newest control coefficient.
